(19) United States
(12) Patent Application Publication
(10) Pub. No.: US 2025/0184702 A1
(43) Pub. Date: Jun. 5, 2025

(54) INTELLIGENT DISCOVERY SERVER MANAGEMENT

(71) Applicant: T-MOBILE INNOVATIONS LLC, Overland Park, KS (US)

(72) Inventors: Anjani Deepthi NANDIGAM, Bothell, WA (US); Zoltan Homorodi, North Bend, WA (US); Nilesh Ranjan, Sammamish, WA (US)

(21) Appl. No.: 18/526,642

(22) Filed: Dec. 1, 2023

(51) Int. Cl. H04W 4/50; H04W 8/20; H04W 8/24

(52) U.S. Cl. CPC H04W 4/50; H04W 8/205; H04W 8/24

(57) ABSTRACT

Systems and methods enable a framework that manages multiple discovery servers and different device activations and provisioning. Initially, a request for a service corresponding to a user equipment (UE) is received at a discovery management server. The discovery management server determines a discovery server corresponding to the UE. A push notification or a pull request is communicated by the discovery management server to the discovery server. Information corresponding to the service in association with the UE is stored at a database of the discovery management server.

### SUMMARY

A high-level overview of various aspects of the present technology is provided in this section to introduce a selection of concepts that are further described below in the detailed description section of this disclosure. This summary is not intended to identify key or essential features of the claimed subject matter, nor is it intended to be used as an aid in isolation to determine the scope of the claimed subject matter.

In aspects set forth herein, systems and methods are provided for intelligent discovery server management. More particularly, in aspects set forth herein, systems and methods enable a framework that manages multiple discovery servers and different device activations and provisioning. Initially, a request for a service corresponding to a user equipment (UE) is received at a discovery management server. The discovery management server determines a discovery server corresponding to the UE. A push notification or a pull request is communicated by the discovery management server to the discovery server. Information corresponding to the service in association with the UE is stored at a database of the discovery management server.

### BRIEF DESCRIPTION OF THE SEVERAL VIEWS OF THE DRAWINGS

Implementations of the present disclosure are described in detail below with reference to the attached drawing figures, wherein:

FIG. 1 depicts a diagram of an exemplary network environment in which implementations of the present disclosure may be employed;

FIG. 2 depicts a representation of a wireless network in which one or more aspects of the present disclosure may be carried out, in accordance with aspects herein;

FIG. 3 depicts a flow diagram of a method for intelligent discovery server management, in accordance with aspects herein; and

FIG. 4 depicts a diagram of an exemplary computing environment suitable for use in implementations of the present disclosure.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Throughout this disclosure, several acronyms and shorthand notations are employed to aid the understanding of certain concepts pertaining to the associated system and services. These acronyms and shorthand notations are intended to help provide an easy methodology of communicating the ideas expressed herein and are not meant to limit the scope of embodiments described in the present disclosure. The following is a list of these acronyms:
3G Third-Generation Wireless Technology
4G Fourth-Generation Cellular Communication System
5G Fifth-Generation Cellular Communication System
6G Sixth-Generation Cellular Communication System
AI Artificial Intelligence
CD-ROM Compact Disk Read Only Memory
CDMA Code Division Multiple Access
eNodeB Evolved Node B
GIS Geographic/Geographical/Geospatial Information System
gNodeB Next Generation Node B
GPRS General Packet Radio Service
GSM Global System for Mobile communications
iDEN Integrated Digital Enhanced Network
DVD Digital Versatile Discs
EEPROM Electrically Erasable Programmable Read Only Memory
LED Light Emitting Diode
LTE Long Term Evolution
MIMO Multiple Input Multiple Output
MD Mobile Device
ML Machine Learning
PC Personal Computer
PCS Personal Communications Service
PDA Personal Digital Assistant
PDSCH Physical Downlink Shared Channel
PHICH Physical Hybrid ARQ Indicator Channel
PUCCH Physical Uplink Control Channel
PUSCH Physical Uplink Shared Channel
RAM Random Access Memory
RET Remote Electrical Tilt
RF Radio-Frequency
RFI Radio-Frequency Interference
R/N Relay Node
RNR Reverse Noise Rise
ROM Read Only Memory
RSRP Reference Signal Receive Power
RSRQ Reference Signal Receive Quality
RSSI Received Signal Strength Indicator
SINR Transmission-to-Interference-Plus-Noise Ratio
SNR Transmission-to-noise ratio
SON Self-Organizing Networks
TDMA Time Division Multiple Access
TXRU Transceiver (or Transceiver Unit)
UE User Equipment
UMTS Universal Mobile Telecommunications Systems
WCD Wireless Communication Device (interchangeable with UE)

Further, various technical terms are used throughout this description. An illustrative resource that fleshes out various aspects of these terms can be found in Newton's Telecom Dictionary, 32^{nd} Edition (2022).

By way of background, a traditional telecommunications network employs a plurality of base stations (i.e., access point, node, cell sites, cell towers) to provide network coverage. The base stations are employed to broadcast and transmit transmissions to user devices of the telecommunications network. An access point may be considered to be a portion of a base station that may comprise an antenna, a radio, and/or a controller. In aspects, an access point is defined by its ability to communicate with a user equipment (UE), such as a wireless communication device (WCD), according to a single protocol (e.g., 3G, 4G, LTE, 5G, and the like); however, in other aspects, a single access point may communicate with a UE according to multiple protocols. As used herein, a base station may comprise one access point or more than one access point. Factors that can affect the telecommunications transmission include, e.g., location and size of the base stations, and frequency of the transmission, among other factors. The base stations are employed to broadcast and transmit transmissions to user devices of the telecommunications network. Traditionally, the base station establishes uplink (or downlink) transmission with a mobile handset over a single frequency that is exclusive to that particular uplink connection (e.g., an LTE connection with an eNodeB). In this regard, typically only one active uplink connection can occur per frequency. The base station may include one or more sectors served by individual transmitting/receiving components associated with the base station (e.g., antenna arrays controlled by an eNodeB). These transmitting/receiving components together form a multi-sector broadcast arc for communication with mobile handsets linked to the base station.

As used herein, “base station” is one or more transmitters or receivers or a combination of transmitters and receivers, including the accessory equipment, necessary at one location for providing a service involving the transmission, emission, and/or reception of radio waves for one or more specific telecommunication purposes to a mobile station (e.g., a UE), wherein the base station is not intended to be used while in motion in the provision of the service.

The term/abbreviation UE (also referenced herein as a user device or wireless communications device (WCD)) can include any device employed by an end-user to communicate with a telecommunications network, such as a wireless telecommunications network. A UE can include a mobile device, a mobile broadband adapter, or any other communications device employed to communicate with the wireless telecommunications network.

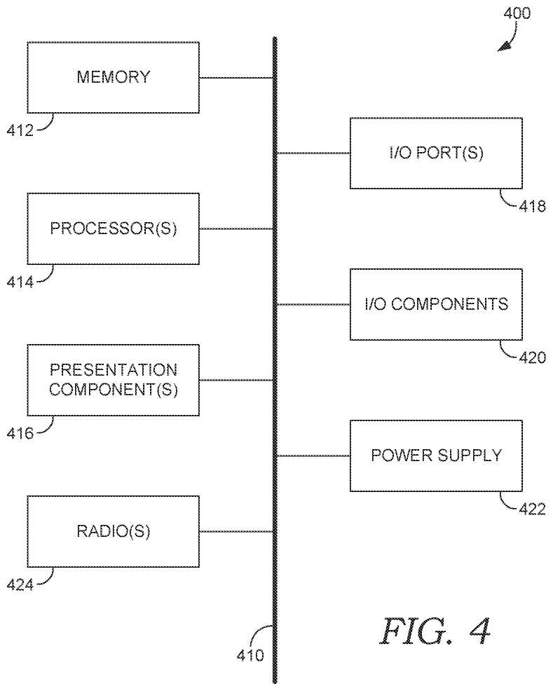

For an illustrative example, a UE can include cell phones, smartphones, tablets, laptops, small cell network devices (such as micro cell, pico cell, femto cell, or similar devices), and so forth. Further, a UE can include a sensor or set of sensors coupled with any other communications device employed to communicate with the wireless telecommunications network; such as, but not limited to, a camera, a weather sensor (such as a rain gage, pressure sensor, thermometer, hygrometer, and so on), a motion detector, or any other sensor or combination of sensors. A UE, as one of ordinary skill in the art may appreciate, generally includes one or more antennas coupled to a radio for exchanging (e.g., transmitting and receiving) transmissions with a nearby base station or access point. A UE may be, in an embodiment, similar to device 400 described herein with respect to FIG. 4.

Discovery servers are utilized to provision a digital subscriber identity module (eSIM) to a UE that enables the UE to communicate via a network provided by a mobile network operator (MNO). Original equipment manufacturers (OEMs) are beginning to develop proprietary discovery servers to have better control over configurations and requirements for their devices. However, an increasing number of configurations and requirements make it increasingly difficult for MNOs to offer and manage devices of multiple OEMs without relying on additional vendors.

The present disclosure is directed to systems, methods, and computer readable media for providing an intelligent discovery server management. More particularly, in aspects set forth herein, systems and methods enable a framework that manages multiple discovery servers and different device activations and provisioning. Initially, a request for a service corresponding to a user equipment (UE) is received at a discovery management server. The discovery management server determines a discovery server corresponding to the UE. A push notification or a pull request is communicated by the discovery management server to the discovery server. Information corresponding to the service in association with the UE is stored at a database of the discovery management server.

In a first aspect of the present invention, computer-readable media is provided, the computer-readable media having computer-executable instructions embodied thereon that, when executed, perform a method of intelligent discovery server management. The method comprises receiving, at a discovery server management engine, a request for a service corresponding to a user equipment (UE). The method also comprises determining, by the discovery server management engine, a discovery server corresponding to the UE. The discovery server may be based on an original equipment manufacturer (OEM) of the UE. The method further comprises communicating, by the discovery server management engine, a push notification or a pull request to the discovery server corresponding to the UE. The method also comprises, storing, at a database of the discovery server management engine, information corresponding to the service in association with the UE.

A second aspect of the present disclosure is directed to a method of intelligent discovery server management. The method include receiving, at a discovery server management engine, a request for a service corresponding to a user equipment (UE). The service comprises a digital subscriber identity module (eSIM) for the UE. The method also includes determining, by the discovery server management engine, a discovery server corresponding to the UE, the discovery server based on an original equipment manufacturer (OEM) of the UE. The method further includes communicating, by the discovery server management engine, a push notification or a pull request to the discovery server corresponding to the UE.

Another aspect of the present disclosure is directed to a system of intelligent beamforming. The system comprises a UE and discovery server management engine that: receives a request for a service corresponding to the UE; determines a discovery server corresponding to the UE, the discovery server based on an original equipment manufacturer (OEM) of the UE; communicates a push notification or a pull request to the discovery server corresponding to the UE; and stores information corresponding to the service in association with the UE.

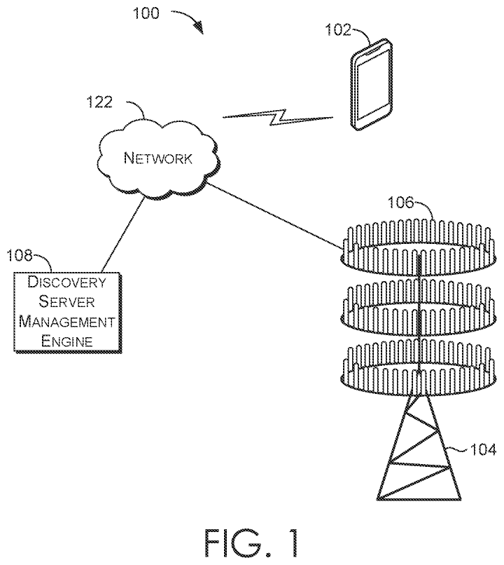

Turning to FIG. 1, a network environment suitable for use in implementing embodiments of the present disclosure is provided. Such a network environment is illustrated and designated generally as network environment 100. Network environment 100 is but one example of a suitable network environment and is not intended to suggest any limitation as to the scope of use or functionality of the disclosure. Neither should the network environment 100 be interpreted as having any dependency or requirement relating to any one or combination of components illustrated.

A network cell may comprise a base station to facilitate wireless communication between a communications device within the network cell, such as communications device 1100 described with respect to FIG. 11, and a network. As shown in FIG. 1, a communications device may be a UE 102. In the network environment 100, UE 102 may communicate with other devices, such as mobile devices, servers, etc. The UE 102 may take on a variety of forms, such as a personal computer, a laptop computer, a tablet, a netbook, a mobile phone, a Smart phone, a personal digital assistant, or any other device capable of communicating with other devices. For example, the UE 102 may take on any form such as, for example, a mobile device or any other computing device capable of wirelessly communication with the other devices using a network. Makers of illustrative devices include, for example, Research in Motion, Creative Technologies Corp., Samsung, Apple Computer, and the like. A device can include, for example, a display(s), a power source(s) (e.g., a battery), a data store(s), a speaker(s), memory, a buffer(s), and the like. In embodiments, UE 102 comprises a wireless or mobile device with which a wireless telecommunication network(s) can be utilized for communication (e.g., voice and/or data communication). In this regard, the UE 102 can be any mobile computing device that communicates by way of, for example, a 5G network.

The UE 102 may utilize network 122 to communicate with other computing devices (e.g., mobile device(s), a server(s), a personal computer(s), etc.). In embodiments, network 122 is a telecommunications network, or a portion thereof. A telecommunications network might include an array of devices or components, some of which are not shown so as to not obscure more relevant aspects of the invention. Components such as terminals, links, and nodes (as well as other components) may provide connectivity in some embodiments. Network 122 may include multiple networks, as well as being a network of networks, but is shown in more simple form so as to not obscure other aspects of the present disclosure. Network 122 may be part of a telecommunications network that connects subscribers to their immediate service provider. In embodiments, network 122 is associated with a telecommunications provider that provides services to user devices, such as UE 102. For example, network 122 may provide voice services to user devices or corresponding users that are registered or subscribed to utilize the services provided by a telecommunications provider. Although it is contemplated network 122 can be any communication network providing voice and/or data service(s), such as, for example, a 1× circuit voice, a 3G network (e.g., CDMA, CDMA1000, WCDMA, GSM, UMTS), a 4G network (WiMAX, LTE, HSDPA), or the like, network 122 is depicted in FIG. 1 as a 5G network.

The network environment 100 may include a database (not shown). The database may be similar to the memory component 1112 in FIG. 11 and can be any type of medium that is capable of storing information. The database can be any collection of records (e.g., network or device information). In one embodiment, the database includes a set of embodied computer-executable instructions that, when executed, facilitate various aspects disclosed herein. These embodied instructions will variously be referred to as “instructions” or an “application” for short.

As previously mentioned, the UE 102 may communicate with other devices by using a base station, such as base station 104. In embodiments, base station 104 is a wireless communications station that is installed at a fixed location, such as at a radio tower, as illustrated in FIG. 1. The radio tower may be a tall structure designed to support one or more antennas 106 for telecommunications and/or broadcasting. In other embodiments, base station 104 is a mobile base station. The base station 104 may be an MMU and include gNodeB for mMIMO/5G communications via network 122. In this way, the base station 104 can facilitate wireless communication between UE 102 and network 122.

As stated, the base station 104 may include a radio (not shown) or a remote radio head (RRH) that generally communicates with one or more antennas associated with the base station 104. In this regard, the radio is used to transmit signals or data to an antenna 106 associated with the base station 104 and receive signals or data from the antenna 106. Communications between the radio and the antenna 106 can occur using any number of physical paths. A physical path, as used herein, refers to a path used for transmitting signals or data. As such, a physical path may be referred to as a radio frequency (RF) path, a coaxial cable path, cable path, or the like.

The antenna 106 is used for telecommunications. Generally, the antenna 106 may be an electrical device that converts electric power into radio waves and converts radio waves into electric power. The antenna 106 is typically positioned at or near the top of the radio tower as illustrated in FIG. 1. Such an installation location, however, is not intended to limit the scope of embodiments of the present invention. The radio associated with the base station 104 may include at least one transceiver configured to receive and transmit signals or data.

Continuing, the network environment 100 may further include a discovery server management engine 108. The discovery server management engine 108 may be configured to, among other things, provides a framework for managing discovery server activities, in accordance with the present disclosure. Though discovery server management engine 108 is illustrated as a standalone device (e.g., a server having one or more processors) in FIG. 1, it may be a service provided via the network 122, or may be remotely located.

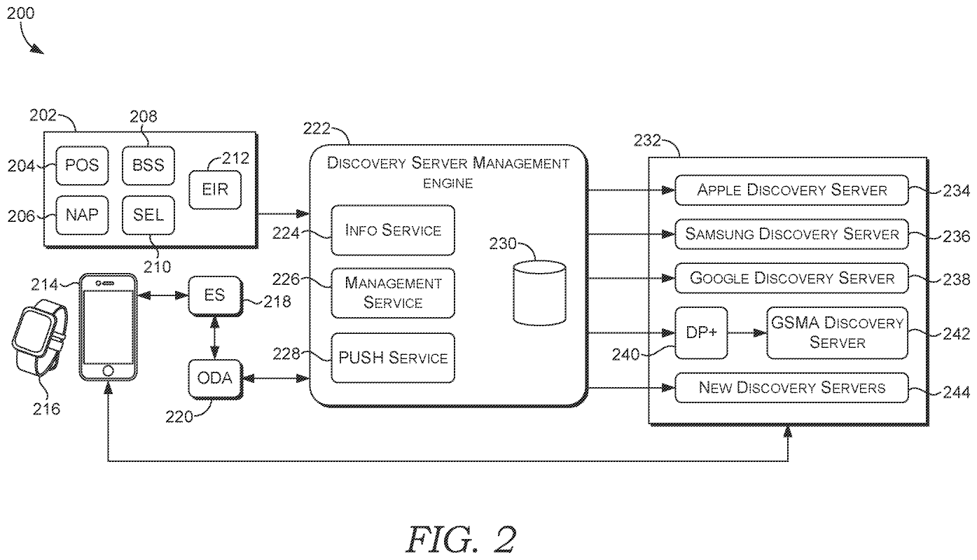

Referring now to FIG. 2, the discovery server management engine 222 may include, among other things, info service 224, management service 226, push service 228, and database 230. The discovery server management engine 222 may receive, among other things, receive requests for services corresponding to user devices, such as UE 102, within a network cell associated with a base station 104. For example, various device activations and provisioning may be needed for a UE 102 to provide activation or certain features to the UE 102.

Info service 224 generally receives information from various device activities and from applications within the network. For example, info service 224 may receive device type and model information corresponding to a UE. Info service 224 may also receive device type and discovery information corresponding to one or more discovery servers. Info service 224 may also receive brand and billing information, SKU information, subscriber activity events, device restrictions, and discovery server configuration. The information may be stored in database 230.

Management service 226 generally generates a mapping between a SKU, brand, and discovery server to facilitate an OEM and/or mobile virtual network operator (MVNO) to meet relevant requirements. For example, an MVNO can define services names for different SKUs. In another example, an OEM can opt to receive push notifications for particular models or particular plans. Various rules may be applied depending on these requirements and enables the discovery server management engine 222 to ensure updates and/or services are provided to the appropriate UEs. In some aspects, once an OEM opts for a PUSH or PULL mechanism for a discovery server, rules can be applied by the management service 226 accordingly.

Push service 228 generally enables push notifications to be sent to the relevant discovery server for a particular device (e.g., APPLE discovery server 234, SAMSUNG discovery server 236, GOOGLE discovery server 238, GSMA discovery server 242, or new discovery servers 244. Push service 226 may provide the ability to define a service name that is visible when receiving a push notification at the UE 102. Service names may be defined based on a discovery server, a device model, a brand, SKU information, and/or subscriber activity. Push notifications may enable additional services or updates to be provide to the UE 102 and may be initiated by the OEM, the MNO, or the user. If a particular service or update is cancelled before being pushed to the UE 102, the discovery server management engine 222 is able to delete the push notification, in some aspects.

Push service 226 may enable device owners to not receive push notifications for particular device models. Additionally or alternatively, push service 226 may enable device owners to restrict push notifications for particular device models. For example, restrictions can be applied based on SKU, brand, and/or account activity.

In practice, a user may desire to active a new device, such as UE 214. To do so, the user needs to download an eSIM profile corresponding to a mobile subscription of the user. Although the eSIM may be downloaded different ways, the UE 214 needs to communicate directly or indirectly with a discovery server 232. In some aspects, the discovery server is non-proprietary, such as the GSMA discovery server 242. In this example, the MNO has a subscription management server, such as DP+ 240, that has a profile for the UE 214 and communicates with the GSMA discovery server 242, allowing the UE 214 to acquire the eSIM.

In examples where the OEM maintains their own discovery server (e.g., APPLE discover server 234, SAMSUNG discovery server 236, GOOGLE discovery server 238, or new discovery servers 244), the discovery server management engine 222 facilitates the activation process. For example, the discovery server management engine 222 stores information including: type and model information corresponding to a UE, device type and discovery information corresponding to one or more discovery servers, receive brand and billing information, SKU information, subscriber activity events, device restrictions, and discovery server configuration. When the user desires to active the new device, the discover server management engine 222 brokers the connection to the correct discovery server 232 based on the information mapped and stored in database 230 and the eSIM is pushed to the UE.

In another example, a user may wish to pair a smartwatch 216 with a UE 214. To do so the user may setup an eSIM subscription for the smartwatch 216 by initially communicating with the entitlement server 218. The entitlement server 218 communicates with the discovery server management engine 222 via ODA 220 and the eSIM is pushed to the UE by the appropriate discovery server 232. The entitlement server 218 also links the smartwatch eSIM subscription with the eSIM of the smart phone, ensuring both devices ring when the user receives a telephone call.

Other subscriptions or activations may be necessitated by the MNO as indicated at various MNO components 202. For example, if the user purchases a feature or subscription, such as via a point of sale server 204 or the billing service server 208. Moreover, subscriptions or activations may be necessitated when subscriber details are modified at the NAP server 206. In some aspects, a device may be blacklisted and the Equipment Identity Register 212 may communicate with the discovery server management engine 222 to remove or restrict services or functionality of the UE.

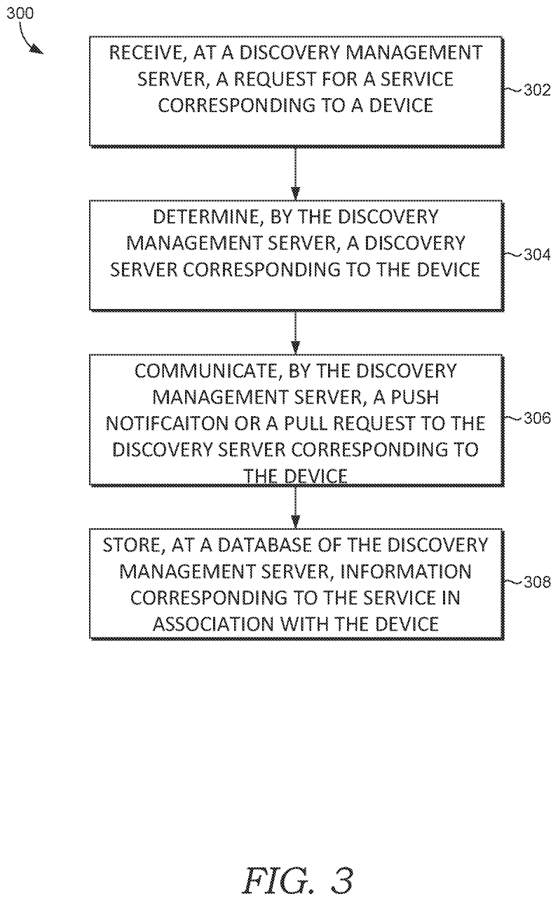

In FIG. 3, a flow diagram is provided depicting a method 300 for intelligent discovery server management, in accordance with aspects of the present invention. Method 300 may be performed by any computing device (such as computing device described with respect to FIG. 4) with access to a discovery server management engine (such as the one described with respect to FIG. 1 or 2) or by one or more components of the network environment described with respect to FIG. 1 or 2 (such as discovery server management engine 108 or discovery server management engine 222).

Initially, at step 302, a request for a service corresponding to a UE is received at a discovery server management engine. A service name for the service defined by a mobile virtual network operator corresponding to the UE may be received. The service name may be based on one or more of the discovery server, a model of the UE, a brand of the UE, stock keeping unit (SKU) information corresponding to the UE, or subscriber activity. In some aspects, the request for the service is initiated by the UE. In other aspects, the request for the service is initiated by a mobile network operator or a mobile virtual network operator corresponding to the UE. The service may comprise a digital subscriber identity module (eSIM) for the UE.

At step 304, a discovery server corresponding to the UE is determined by the discovery server management engine. The discovery server may be based on an OEM of the UE. In some aspects, an OEM request is received from the OEM of the UE to not allow push notifications for the UE. In other aspects, an OEM request is received from the OEM of the UE to restrict push notifications for the UE. The OEM request may be associated with a brand of the UE, SKU information corresponding to the UE, or subscriber activity.

At step 306, a push notification or a pull request to the discovery server corresponding to the UE is communicated by the discovery server management engine. In some aspects, the push notification or the pull request is dependent on a selection made by the OEM on how to communicate with the UE.

At step 308, information corresponding to the service in association with the UE is stored at a database of the discovery server management engine. In some aspects, the information corresponding to the discovery server comprises a configuration of the discovery server. In some aspects, a UE type, a model of the UE, information corresponding to the discovery server, service names associated with the UE, a brand of the UE, billing information corresponding to a subscriber associated with the UE, SKU information corresponding to the UE, subscriber activity, and restrictions for the UE may also be stored at the database of the discovery server management engine. In some aspects, a mapping, at the database of the discovery server, between the SKU information, the brand of the UE, and the information corresponding to the discovery server may also be stored at the database of the discovery server management engine.

In some aspects, a configuration for a discovery server that has an update available for the UE may be communicated to the UE. In other aspects, an indication may be received from a mobile network operator that an update is available for the UE.

Embodiments of the technology described herein may be embodied as, among other things, a method, a system, or a computer-program product. Accordingly, the embodiments may take the form of a hardware embodiment, or an embodiment combining software and hardware. The present technology may take the form of a computer-program product that includes computer-useable instructions embodied on one or more computer-readable media. The present technology may further be implemented as hard-coded into the mechanical design of network components and/or may be built into a broadcast cell or central server.

Computer-readable media includes both volatile and non-volatile, removable and non-removable media, and contemplate media readable by a database, a switch, and/or various other network devices. Network switches, routers, and related components are conventional in nature, as are methods of communicating with the same. By way of example, and not limitation, computer-readable media may comprise computer storage media and/or non-transitory communications media.

Computer storage media, or machine-readable media, may include media implemented in any method or technology for storing information. Examples of stored information include computer-useable instructions, data structures, program modules, and other data representations. Computer storage media may include, but are not limited to, RAM, ROM, EEPROM, flash memory or other memory technology, CD-ROM, digital versatile discs (DVD), holographic media or other optical disc storage, magnetic cassettes, magnetic tape, magnetic disk storage, and/or other magnetic storage devices. These memory components may store data momentarily, temporarily, and/or permanently, and are not limited to the examples provided.

Communications media typically store computer-useable instructions—including data structures and program modules—in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

Referring to FIG. 4, a block diagram of an exemplary computing device 400 suitable for use in implementations of the technology described herein is provided. In particular, the exemplary computer environment is shown and designated generally as computing device 400. Computing device 400 is but one example of a suitable computing environment and is not intended to suggest any limitation as to the scope of use or functionality of the invention. Neither should computing device 400 be interpreted as having any dependency or requirement relating to any one or combination of components illustrated. It should be noted that although some components in FIG. 4 are shown in the singular, they may be plural. For example, the computing device 400 might include multiple processors or multiple radios. In aspects, the computing device 400 may be a UE/WCD, or other user device, capable of two-way wireless communications with an access point. Some non-limiting examples of the computing device 400 include a cell phone, tablet, pager, personal electronic device, wearable electronic device, activity tracker, desktop computer, laptop, PC, and the like.

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

As shown in FIG. 4, computing device 400 includes a bus 410 that directly or indirectly couples various components together, including memory 412, processor(s) 414, presentation component(s) 416 (if applicable), radio(s) 424, input/output (I/O) port(s) 418, input/output (I/O) component(s) 420, and power supply(s) 422. Although the components of FIG. 4 are shown with lines for the sake of clarity, in reality, delineating various components is not so clear, and metaphorically, the lines would more accurately be grey and fuzzy. For example, one may consider a presentation component such as a display device to be one of I/O components 420. Also, processors, such as one or more processors 414, have memory. The present disclosure hereof recognizes that such is the nature of the art, and reiterates that FIG. 4 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of the present disclosure and refer to “computer” or “computing device.”

Memory 412 may take the form of memory components described herein. Thus, further elaboration will not be provided here, but it should be noted that memory 412 may include any type of tangible medium that is capable of storing information, such as a database. A database may be any collection of records, data, and/or information. In one embodiment, memory 412 may include a set of embodied computer-executable instructions that, when executed, facilitate various functions or elements disclosed herein. These embodied instructions will variously be referred to as “instructions” or an “application” for short.

Processor 414 may actually be multiple processors that receive instructions and process them accordingly. Presentation component 416 may include a display, a speaker, and/or other components that may present information (e.g., a display, a screen, a lamp (LED), a graphical user interface (GUI), and/or even lighted keyboards) through visual, auditory, and/or other tactile cues.

Radio 424 represents a radio that facilitates communication with a wireless telecommunications network. Illustrative wireless telecommunications technologies include CDMA, GPRS, TDMA, GSM, and the like. Radio 424 might additionally or alternatively facilitate other types of wireless communications including Wi-Fi, WiMAX, LTE, 3G, 4G, LTE, mMIMO/5G, NR, VOLTE, or other VoIP communications. As can be appreciated, in various embodiments, radio 424 can be configured to support multiple technologies and/or multiple radios can be utilized to support multiple technologies. A wireless telecommunications network might include an array of devices, which are not shown so as to not obscure more relevant aspects of the invention. Components such as a base station, a communications tower, or even access points (as well as other components) can provide wireless connectivity in some embodiments.

The input/output (I/O) ports 418 may take a variety of forms. Exemplary I/O ports may include a USB jack, a stereo jack, an infrared port, a firewire port, other proprietary communications ports, and the like. Input/output (I/O) components 420 may comprise keyboards, microphones, speakers, touchscreens, and/or any other item usable to directly or indirectly input data into the computing device 400.

Power supply 422 may include batteries, fuel cells, and/or any other component that may act as a power source to supply power to the computing device 400 or to other network components, including through one or more electrical connections or couplings. Power supply 422 may be configured to selectively supply power to different components independently and/or concurrently.

Many different arrangements of the various components depicted, as well as components not shown, are possible without departing from the scope of the claims below. Embodiments of our technology have been described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

The invention claimed is:

1. One or more computer-readable media having computer-executable instructions embodied thereon that, when executed, perform a method for intelligent discovery server management, the method comprising:
receiving, at a discovery server management engine, a request for a service corresponding to a user equipment (UE);
determining, by the discovery server management engine, a discovery server corresponding to the UE, the discovery server based on an original equipment manufacturer (OEM) of the UE;
communicating, by the discovery server management engine, a push notification or a pull request to the discovery server corresponding to the UE; and
storing, at a database of the discovery server management engine, information corresponding to the service in association with the UE.

2. The media of claim 1, further comprising receiving a service name for the service defined by a mobile virtual network operator corresponding to the UE.

3. The media of claim 2, wherein the service name is based on one or more of the discovery server, a model of the UE, a brand of the UE, stock keeping unit (SKU) information corresponding to the UE, or subscriber activity.

4. The media of claim 1, further comprising receiving an OEM request from the OEM of the UE to not allow push notifications for the UE, the OEM request associated with a brand of the UE, stock keeping unit (SKU) information corresponding to the UE, or subscriber activity.

5. The media of claim 1, further comprising receiving an OEM request from the OEM of the UE to restrict push notifications for the UE, the OEM request associated with a brand of the UE, stock keeping unit (SKU) information corresponding to the UE, or subscriber activity.

6. The media of claim 1, further comprising storing a UE type, a model of the UE, information corresponding to the discovery server, service names associated with the UE, a brand of the UE, billing information corresponding to a subscriber associated with the UE, stock keeping unit (SKU) information corresponding to the UE, subscriber activity, and restrictions for the UE.

7. The media of claim 6, wherein the information corresponding to the discovery server comprises a configuration of the discovery server.

8. The media of claim 6, further comprising storing a mapping, at the database of the discovery server, between the SKU information, the brand of the UE, and the information corresponding to the discovery server.

9. The media of claim 1, wherein the request for the service is initiated by the UE.

10. The media of claim 1, wherein the request for the service is initiated by a mobile network operator or a mobile virtual network operator corresponding to the UE.

11. The media of claim 1, wherein the service comprises a digital subscriber identity module (eSIM) for the UE.

12. The media of claim 1, further comprising communicating to the UE a configuration for a discovery server that has an update available for the UE.

13. The media of claim 1, further comprising receiving an indication from a mobile network operator that an update is available for the UE.

14. A method for intelligent discovery server management, the method comprising:
receiving, at a discovery server management engine, a request for a service corresponding to a user equipment (UE), the service comprising a digital subscriber identity module (eSIM) for the UE;
determining, by the discovery server management engine, a discovery server corresponding to the UE, the discovery server based on an original equipment manufacturer (OEM) of the UE; and
communicating, by the discovery server management engine, a push notification or a pull request to the discovery server corresponding to the UE.

15. The method of claim 14, further comprising storing, at a database of the discovery server management engine, information corresponding to the service in association with the UE.

16. The method of claim 14, further comprising:
receiving an OEM request from the OEM of the UE to not allow push notifications for the UE, the OEM request associated with a brand of the UE, stock keeping unit (SKU) information corresponding to the UE, or subscriber activity; or
receiving an OEM request from the OEM of the UE to restrict push notifications for the UE, the OEM request associated with a brand of the UE, stock keeping unit (SKU) information corresponding to the UE, or subscriber activity.

17. The method of claim 14, wherein the request for the service is initiated by the UE.

18. The method of claim 14, wherein the request for the service is initiated by a mobile network operator or a mobile virtual network operator corresponding to the UE.

19. The method of claim 14, further comprising communicating to the UE a configuration for a discovery server that has an update available for the UE.

20. A system for intelligent discovery server management, the system comprising:
a user equipment (UE); and
a discovery server management engine that:
receives a request for a service corresponding to the UE;
determines a discovery server corresponding to the UE, the discovery server based on an original equipment manufacturer (OEM) of the UE;
communicates a push notification or a pull request to the discovery server corresponding to the UE; and
stores information corresponding to the service in association with the UE.
